(19) United States
(12) Patent Application Publication
(10) Pub. No.: US 2007/0064784 A1
(43) Pub. Date: Mar. 22, 2007

(54) Communication network and method for simulating or designing thereof

(76) Inventors: Shirin Fatemeh Dehghan, Newbury (GB); Mohsen Zadeh-Koochak, Newbury (GB)

Correspondence Address: MCGARRY BAIR PC, 171 MONROE AVENUE, N.W., SUITE 600, GRAND RAPIDS, MI, 49503, US

(21) Appl. No.: 10/539,475

(22) PCT Filed: Dec. 18, 2003
(86) PCT No.: PCT/GB03/05589

§ 371 Date: Nov. 30, 2005

(30) Foreign Application Priority Data
Dec. 18, 2002 (GB) 0229544.2

(51) Int. Cl. H04B 17/00

(52) U.S. Cl. 375/224

(57) ABSTRACT

A method (800) of simulating or designing a communication network supporting communication between a plurality of communication units. The method comprises the step of employing (855, 860) a simulation tool (300) to resolve a mathematical formula relating to an operation of the communication network. The method further comprises the step of resolving one or more iterative mathematical formula in hardware within a hardware platform (320) of the simulation tool (300). In this manner, a time taken for a Network Operator to simulate, design or optimise a communication network or study the dynamic behaviour of the communication network is significantly reduced.

### FIELD OF THE INVENTION

This invention relates to resource planning in a communication system. The invention is applicable to, but not limited to, resource planning in a third generation wireless communication system.

### BACKGROUND OF THE INVENTION

Wireless communication systems, for example cellular telephony or private mobile radio communication systems, typically provide for radio telecommunication links to be arranged between a plurality of base transceiver stations (BTSs) and a plurality of subscriber units, often termed mobile stations (MSs). Such telecommunication links are arranged to support digital and/or analogue communication signals.

Wireless communication systems are distinguished over fixed communication systems, such as the public switched telephone network (PSTN), principally in that subscriber units/mobile stations move between coverage areas, where communications in the different coverage areas are served by different BTS (and/or different service providers). In doing so, the subscriber units/mobile stations encounter a variable radio propagation environment.

Thus, in order for a system planner to ensure that there is acceptable communications across a wide geographical coverage area, which allows wireless communication signals to be transmitted to, and/or received from, the MSs at different geographical locations, a large number of communication parameters have to be determined. Furthermore, the system planner/network provider needs to ensure that the communication network(s) are designed such that they meet peak usage demand, so that users can make calls as and when required.

In a wireless communication system, each BTS has associated with it a particular geographical coverage area (or cell). Primarily, a particular BTS transmitter power level, together with the type, height and directionality of the antenna that is used, defines a coverage area where a BTS can maintain acceptable communications with MSs operating within its serving cell. In addition, receiver sensitivity performance of receiving wireless communication units also affects a given coverage area. In large cellular communication systems, these cells are combined and often overlapped to produce an extensive and contiguous signal coverage area, whilst the subscriber units/mobile stations move between cells. The cell overlap region is deliberately designed into the system plan to ensure that subscriber units/mobile stations can successfully handover between cells.

A system design based on cells is typically based on an ideal cell pattern. However, an idealised cell pattern never occurs in practice, due to the nature of the terrain and the fact that cell sites and antennae are not ideally located on a regular grid pattern. Therefore, prior to system/network integration, a network designer therefore uses radio-planning tools to estimate the radio propagation for each cell and predict a corresponding coverage area. Based on these propagation models, the network designer is able to develop an initial plan for the network (prior to deployment of the network infrastructure) that is intended to minimise the expected interference. Once a specific infrastructure has been modelled, a simulation algorithm is run a large number of times, for a wide variety of subscriber distribution and parameters, i.e. location of MSs, activity status of MSs and transmit power employed by MSs operating in the network, in order to gain a statistical assessment of the network performance.

On the basis of the results of the software simulation, a variety of network parameter settings are manually adjusted, such as a BTS antenna type, direction, power, height, location or radio resource management such as handover parameters, admission control, congestion control etc and other system parameters such as cell reselection, in order to improve the simulation results. The software simulation algorithm is then re-run and so on for further parameter alterations. Thus, the simulation phase is designed to converge to a set of parameter settings that allow the performance of the network to reach a predefined performance level, prior to network installation.

The simulation algorithms that are run are technology dependent. For example, different methods for assessing the network interference and quality are required for a Code Division Multiple Access (CDMA) technology, as defined for implementing the third generation (3G) mobile communication systems, as compared to the Time Division Multiple Access (TDMA) technique employed by the second generation (2G) global system for mobile communications (GSM). An inherent feature of CDMA is that all mobile network users have access to the whole frequency bandwidth all of the time. Thus a frequency reuse of one is a well-known feature of CDMA based systems. This means that the power emanated by the subscriber units and the base station, respectively termed user equipment (UE) and Node Bs in 3G parlance, must be tightly controlled. In order to design, plan, investigate and develop CDMA based systems; a software-based simulation of the network is carried out to ascertain, in particular, the transmit power levels employed by each Node B and each UE.

Part of a CDMA simulation involves solving certain mathematical formulations, for which there is no known ‘closed-form’ solution. For this reason a numerical technique is employed whereby an initial solution is ‘guessed’ and is iteratively modified until the true solution is obtained. In order to ascertain when the final solution is reached, a ‘convergence criterion’ is defined, and the solution is then said to have “converged”.

A known iterative algorithm 100 used for power convergence in CDMA-based simulation applications, notably written entirely in software, is illustrated in FIG. 1. The iterative algorithm 100 comprises two phases:
(i) an initialisation phase 110, where all components of a network, such as cells and UEs etc., are executed as machine code; and
(ii) an iteration phase 150.

In the initialisation phase 110, network information is read into computer memory, such as coverage information in step 115, Node B information in step 120, UE information in step 125 and network parameters in step 130.

The iteration phase 150 comprises a series of computations. In this regard, for each UE and Node B in the network in step 155, the simulation computes a new transmit power in step 160. Once the transmit powers have been computed, the simulation is able to compute the levels of interference caused within each cell and to each of the UEs, as shown in step 165. At the end of the simulation's iteration, a determination is made as to whether the powers have converged, in step 170. If the powers have not converged, i.e. a definitive answer to the interference levels cannot be determined, the process loops 175 and one or more new transmit power level(s) for one or more UEs and/or Node Bs is/are used, as shown in step 155. However, if the powers have converged in step 170, the iterative power/interference level simulations end, as shown in step 180.

The number of “entities” for which a solution must be obtained is also large. For, say, a 50 km by 50 km geographical area there can typically be 6000 Node Bs and 240,000 active UEs. For reasons related to ensuring statistically accurate results, the problem therefore must be solved repeatedly for different configurations (so called snapshots). The execution time required to converge to a solution for a network of this size for 50 snapshots can reach 25 hours. This is because a large number of iterations are required before the solution converges and the necessary computations, at each iteration, are time-consuming.

It is possible to increase the speed of such a simulation algorithm using concurrent (parallel) processing units. However the limiting factor in this case would be the additional overhead of managing communication between the respective processes.

Thus, in summary, the known processes can therefore be extremely long and can consume large amounts of processing power, as each parameter change causes a further iteration having to be validated through the iterative process. Although the resultant selected network parameters do (or should) result in an operative network in practice, the simulation process is lengthy. Furthermore, due to the inordinate time taken to perform such simulations, and the lack of dynamism in the simulation process, it is rare for there to be any subsequent amendment or on-going development of the network after deployment. In addition, in cases where there is limited time to run the simulation, it is possible that a sub-optimal network design is achieved, where the network design merely meets rather than exceeds the network provider's minimum requirements.

Thus, there exists a need in the field of the present invention for an improved method for resource planning in the development and design of a wireless communications network. Furthermore, there exists a need to provide a cell-based communication system that can be continuously optimised through on-going simulations, wherein the aforementioned disadvantages may be alleviated.

### STATEMENT OF INVENTION

In accordance with a first aspect of the present invention there is provided a method of simulating or designing a communication network, as claimed in claim 1.

In accordance with a second aspect of the present invention, there is provided a communication network, as claimed in claim 12.

In accordance with a third aspect of the present invention, there is provided a communication unit, as claimed in claim 13.

In accordance with a fourth aspect of the present invention, there is provided a storage medium, as claimed in claim 14.

In accordance with a fifth aspect of the present invention, there is provided a simulation tool, as claimed in claim 15.

In accordance with a sixth aspect of the present invention, there is provided a simulation tool, as claimed in claim 16.

In accordance with a seventh aspect of the present invention, there is provided a cellular communication system, as claimed in claim 29.

In summary, the inventive concepts of the present invention propose an improvement to the known simulation process by specifically improving the iterative stage. The iterative stage is handled in hardware instead of software, which facilitates a more rapid convergence of iterative parameters in equations that have no closed form solution, such as transmit powers. This provides an opportunity to perform rapid adaptation of a practical communication system in response to the on-going simulation.

Apparatus, in the form of a simulation tool, models and simulates a wireless communication network. The simulation tool comprises a configurable hardware platform that models the air interface and is able to achieve rapid convergence (approaching real-time) of a real communication network. A software platform, preferably in the form of a computer, configures the hardware platform and carries out further analysis and presentation of information/results as required.

In one embodiment the communication network under consideration is classed as static, i.e. where mobile communication units remain stationary, as in a “time-freeze” analysis.

In an alternative embodiment the communication network under consideration is classed as dynamic, i.e. where the position of mobiles (or/and surrounding environment affecting the transmitted signals) varies as a function of time.

Typically the method is applied as part of a radio-planning tool and utilised in the selection of radio base station sites, tune transmitter parameters and/or select antenna settings.

In one embodiment the method can be applied as part of a process that computes the optimum network configuration according to predefined criteria.

Typically, a set of data/results output from the hardware platform can be compared to predefined network requirements and a decision reached as to whether they have been met, and when met, assuming that the network parameters are acceptable.

It is envisaged that data relating to the simulation may be stored in a database and relate to any, or any combination, of the following: geographical area to be covered by the network, the number of handsets for which the simulation is to be generated, the status of the handsets i.e. whether moving or static, the power emissions from the handsets and/or base stations, settings of the base stations themselves, and in general any data which can be treated as a predetermined parameter which will not in practice change or change with little or no impact on the network performance.

The simulation tool can be used to generate data results on a real time basis. As an example, if the network geographical area includes a heavily used transport link, such as a motorway, commuter route or rail line, then the usage characteristics may vary largely during any given day as a result of rush hour traffic going in a first direction at the start of the day and the reverse direction at the end of the day with, in between those times, relatively less usage. Thus, the database can hold data to allow the simulation of the use of the network at each of these different usage instances.

Thus, in accordance with the preferred embodiment of the present invention the “state” and power levels of entities in a cellular radio network (base stations and mobile terminals) are simulated by applying voltages to specially designed electronic circuits, causing currents to flow, and measuring the resulting potentials at the output of the circuit.

If desired, the magnitude of applied voltages can be varied to provide dynamism according to the specific instance (i.e. control power levels, traffic distribution etc.) of the network being studied and the output voltages are the resulting power levels of interest. The configuration of the circuit and further analysis, processing and presentation of the output are preferably carried out using the software platform in the form of a processor/computer.

Thus, the need to compute the complex interdependence between the power levels of the base stations and the mobile terminals, in conjunction with the alteration of all other parameter settings and traffic distribution, by time consuming iterative algorithms is substantially eliminated.

### BRIEF DESCRIPTION OF THE DRAWINGS

FIG. 1 is a flow diagram outlining the conventional iterative algorithm used to reach power convergence as part of a code division multiple access (CDMA) based cellular system simulation implemented purely in software and executed within the computer processing unit.

Exemplary embodiments of the present invention will now be described, with reference to the accompanying drawings, in which:

FIG. 2 illustrates a block diagram of a cellular radio communications system adapted to support the various inventive concepts of a preferred embodiment of the present invention;

FIG. 3 is a diagram showing the inter-working of an embodiment of the present invention and illustrating the software/hardware implementation;

FIG. 4 illustrates a specific implementation of the present invention for a simple network (purely for illustrative purposes) comprising one Node B and two UEs;

FIG. 5 illustrates an overview of the interface circuitry required in order for the hardware platform to be configured under software control in accordance with the preferred embodiment of the present invention;

FIG. 6 illustrates a simplistic block diagram of the preferred hardware circuitry used to implement the preferred embodiment of the present invention;

FIG. 7 shows one embodiment of the interface circuitry required in order for the hardware platform to be configured under software control such that the output of the hardware platform is sampled and read back into the computer, in accordance with the preferred embodiment of the present invention; and

FIG. 8 illustrates a flow diagram outlining the simulation algorithm employed in accordance with the preferred embodiment of the present invention.

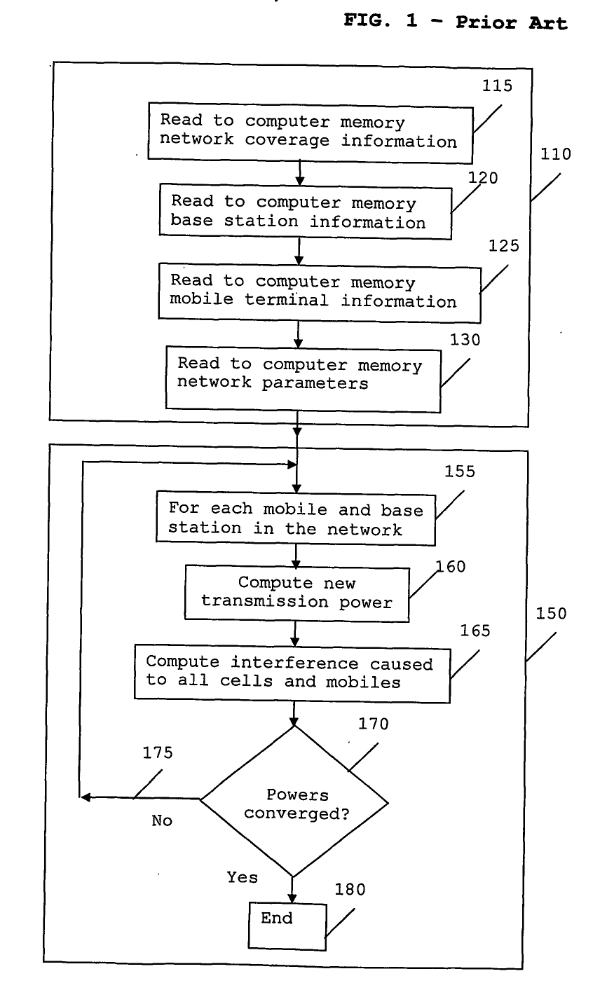

### DESCRIPTION OF PREFERRED EMBODIMENTS

The simulation of a wireless communication system is highly complex, primarily due to the large number of wireless communication elements, such as base stations/Node Bs and subscriber units/ user equipment (UE). Furthermore, the computational execution time of the simulation is lengthy. This limits the speed at which networks can be designed and optimised by cellular Operators.

The preferred embodiment of the present invention is described with reference to a simulation of a 3^{rd} generation cellular communication system, such as a CDMA universal mobile telecommunication system (UMTS) as defined by the European Telecommunication Standards Institute (ETSI). However, the inventive concepts are equally applicable to any other wireless access technologies, such as TDMA, FDMA, OFDMA, etc.

Simulating a CDMA network is primarily concerned with evaluating the powers transmitted by Node Bs and subscriber units. Severe interference exists between these entities. The level of interference is also dependent on their relative positions, which needs to be evaluated within the simulation. In order to combat such levels of interference, both subscriber units /UEs and the Node Bs must adopt appropriate power levels, in order to achieve the predefined quality of service (QoS) for the end user.

It is envisaged that the inventive concepts can be applied in a real-time manner, say, by an Operations and Management Centre (OMC) of a 3G network, to simulate a real-time performance of the network. In this manner, the OMC is able to continuously optimise the performance of the network dependent upon the prevailing and variable conditions. Alternatively, it is envisaged that the simulation aspects of the present invention can be applied by a Network Operator in the initial design of a wireless cellular communication network.

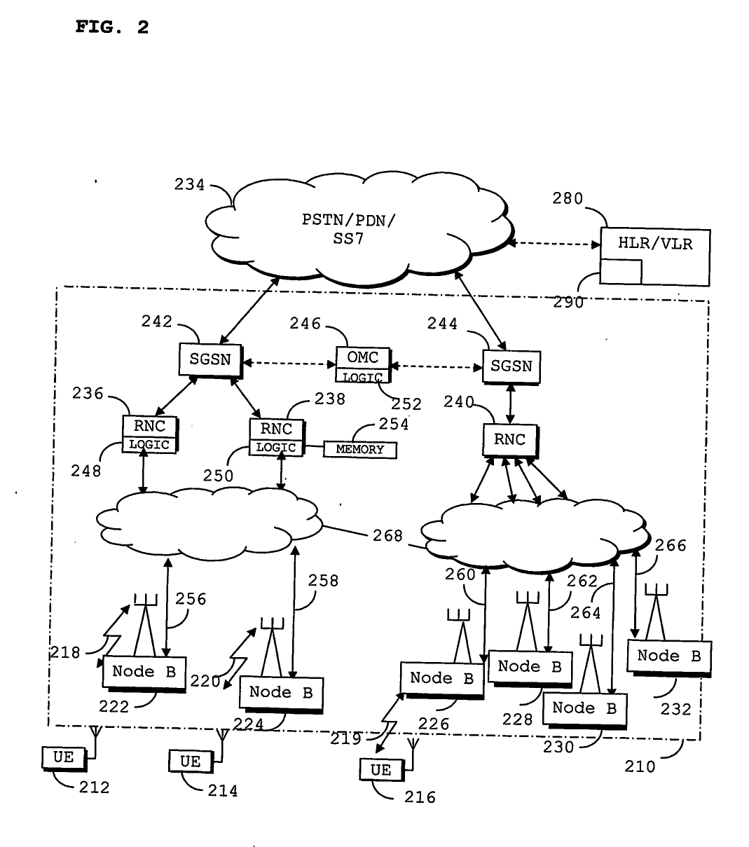

Thus, the foregoing description details how the inventive concepts can be applied to a practical 3G UMTS network, and preferably to the adaptation of system parameters in a pseudo real-time manner as a result of the simulation. Referring first to FIG. 2, a cellular-based telephone communication system 200 is shown in outline, in accordance with a preferred embodiment of the invention in the preferred embodiment of the invention, the cellular-based telephone communication system 200 is compliant with, and contains network elements capable of operating over, a universal mobile telecommunication system (UMTS) and/or a general packet radio system (GPRS) air-interface.

In particular, the simulation aspects of the inventive concepts of the present invention can be applied to the Third Generation Partnership Project (3GPP) specification for wide-band code-division multiple access (WCDMA) standard relating to the UTRAN radio Interface (described in the 3G TS 25.xxx series of specifications developed by ETSI).

Generally, the air-interface protocol is administered from base transceiver sites, referred to under UMTS terminology as Node-Bs, within the network architecture. The Node Bs are geographically spaced apart—one Node B supporting a cell (or, for example, sectors of a cell). A plurality of subscriber terminals (or user equipment (UE) in UMTS nomenclature) 212, 214, 216 communicate over radio links 218, 219, 220 with a plurality of Node-Bs 222, 224, 226, 228, 230, 232. The system comprises many other UEs and Node Bs, which for clarity purposes are not shown.

The wireless communication system, sometimes referred to as a Network Operator's Network Domain, is connected to an external network 234, for example the Internet. The Network Operator's Network Domain (described with reference to both a 3^{rd} generation UMTS and a 2^{nd} generation GSM system) includes:
(i) A core network, namely at least one Gateway GPRS Support Node (GGSN) 244 and/or at least one Serving GPRS Support Nodes (SGSN); and
(ii) An access network, namely:
   (ai) a GPRS (or UMTS) Radio network controller (RNC) 236-240; or
   (aii) Base Site Controller (BSC) in a GSM system and/or
   (bi) a GPRS (or UMTS) Node B 222-232; or
   (bii) a Base Transceiver Station (BTS) in a GSM system.

The GGSN/SGSN 244 is responsible for GPRS (or UMTS) interfacing with a Public Switched Data Network (PSDN) such as the Internet 234 or a Public Switched Telephone Network (PSTN) 234. A SGSN 244 performs a routing and tunnelling function for traffic within say, a GPRS core network, whilst a GGSN 244 links to external packet networks, in this case ones accessing the GPRS mode of the system

The Node-Bs 222-232 are connected to external networks, through base station controllers, referred to under UMTS terminology as Radio Network Controller stations (RNC), including the RNCs 236, 238, 240 and mobile switching centres (MSCs), such as MSC 242 (the others are, for clarity purposes, not shown) and SGSN 244 (the others are, for clarity purposes, not shown).

Each Node-B 222-232 contains one or more transceiver units and communicates with the rest of the cell-based system infrastructure via an I_{ub} interface, as defined in the UMTS specification.

Each RNC 236-240 may control one or more Node-Bs 222-232. Each MSC 242 provides a gateway to the external network 234. The Operations and Management Centre (OMC) 246 is operably connected to RNCs 236-240 and Node-Bs 222-232 (shown only with respect to Node-B 226 for clarity). The OMC 246 administers and manages sections of the cellular telephone communication system 200, as is understood by those skilled in the art. A location registry function 280, comprising home location register and visitor location register details, is shown at a high level in the system architecture, so that the location information is system-wide. A skilled artisan would appreciate that the location registry function 280 may, in alternative embodiments, be operably coupled to lower level elements such as the SGSN 242, 244, a GGSN (not shown) or the OMC 246.

In the preferred embodiment of the present invention, the OMC 246 has been adapted to perform a real-time simulation of the UMTS network. In this regard, the OMC 246 has been adapted to utilise indications of a plurality of Node-B and/or UE power levels. It is known that the power level required by any UE within the simulation may be evaluated using the following general equations.

$$\begin{matrix}{P}_{BS\_to \_m} = {I}_{m} \times \frac{{( {E}_{b} / {N}_{0} )}_{m}}{C / {R}_{m}} \times {L}_{s} & [ 1 ] \\ {I}_{m} = {\sum }_{n = 1 , n \neq s}^{Nbs} {P}_{n} \times \frac{1}{{L}_{n}} + ( {P}_{s} - P m ) \times \frac{1}{{L}_{s}} \times a & [ 2 ]\end{matrix}$$

where:

P_{BS}_{_{—}}ₜₒ_{_{—}}ₘ signifies the required power from the Node-B to the mobile subscriber unit/UE m.

E_{b}/N₀ signifies the energy per bit over noise+interference spectral density; this parameter is crucial in ensuring an acceptable quality of service for mobile subscriber unit/UE m.

C signifies the chip rate for CDMA systems.

Rₘ signifies the data rate for mobile m.

Iₘ represents the interference experienced by mobile m.

Lₛ signifies link loss from the serving base station/Node-B of the mobile subscriber unit/UE m.

Pₙ signifies the total power at other base stations/Node-Bs where n=1 to N bits/s which is the total number of base stations in the network being simulated where n does not equal s, which is the serving base station/Node-B of mobile subscriber unit/UE m a is the non-orthogonality factor.

The equation stated above has no closed-form solution, as P_{BS}_{_{—}}ₜₒ_{_{—}}ₘ depends on Iₘ and Iₘ itself depends on P_{BS}_{_{—}}ₜₒ_{_{—}}ₘ as well as other Node B powers. This is also true when evaluating the powers for mobiles.

The equations become:

$${P}_{m\_to \_BS} = {I}_{BS} \times \frac{{( {E}_{b} / {N}_{0} )}_{m\_to \_BS}}{C / {R}_{m\_to \_BS}} \times {L}_{s} \qquad [ 3 ]$$

where:

$${I}_{m} = {\sum }_{n = 1 , n \neq s}^{{N}_{m}} {P}_{m} \times \frac{1}{{L}_{n}} + ( {P}_{s} - {P}_{m\_to \_BS} ) \times \frac{1}{{L}_{s}} \qquad [ 4 ]$$

In order to solve such equations using traditional methods, many iteration steps are required, where an initial solution is estimated and the last estimate modified at each step until the solution converges to the final value(s).

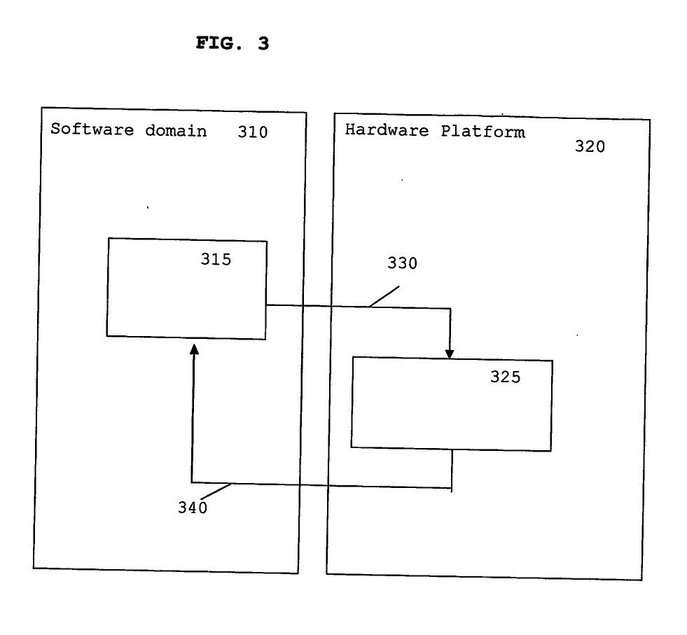

However, in accordance with the preferred embodiment of the present invention, the solving of such equations is greatly simplified by incorporating a hybrid software-hardware system, as described in greater detail with respect to FIG. 3.

In the preferred embodiment of the present invention, it is envisaged that the inventive concepts can be used in a dynamic simulation of a wireless communication network. In this regard, it is envisaged that a processor in the OMC 246 runs the simulation program. However, in alternative embodiments, it is envisaged that such concepts could be implemented in software in any element operably coupled to the OMC 246. Alternatively, the improved simulation algorithm may be located within any other element within the infrastructure, such as a separate analysis platform, or even distributed within a number of elements if appropriate. For example, the improved simulation algorithm could be implemented within the radio access network (RAN) of the cellular infrastructure equipment and/or it may be implemented as a stand-alone element/function on an adjunct platform.

More generally, the improved simulation algorithm may be programmed into, say, the OMC 246 according to the preferred embodiment of the present invention, in any suitable manner. For example, new apparatus may be added to a conventional communication unit. Alternatively existing parts of a conventional communication unit may be adapted, for example, by reprogramming one or more processors therein. As such the required adaptation may be implemented in the form of processor-implementable instructions stored on a storage medium, such as a floppy disk, hard disk, programmable read only memory (PROM), random access memory (RAM) or any combination of these or other storage media.

Referring now to FIG. 3, a hybrid software-hardware system 300 is illustrated in accordance with the preferred embodiment of the present invention. The hybrid software-hardware system 300 illustrates a division of the processing responsibilities between a primarily software-based domain 310 and a primarily hardware-based domain 320. For example, it is envisaged that some of the software-related tasks 315 performed by the software domain may include receiving data from a user or the Network Operator. In accordance with the preferred embodiment of the present invention, namely the real-time adaptation of system parameters based on simulation results, it is envisaged that such data may be received in a real-time manner from elements/communication units within the system architecture, such as Node Bs or MSCs that are cognisant of parameters such as number of UEs, the power levels employed by the UEs or Node Bs, etc. in the system.

In accordance with the preferred embodiment of the present invention, the inventive concepts propose a means of achieving substantially instantaneous convergence of the iterative equations by use of a hardware platform 320 comprising configurable hardware 325. The configurable hardware 325 is specifically implemented to replace the most time consuming parts of the software simulators, which is the iterative convergence section.

In this regard, the software platform 315 provides input signals 330 to the hardware platform 325, according to the particular problem (equation) being solved. The input signals are preferably in the form of voltage levels, but may comprise any suitable electrical variable of a signal, such as current, as would be appreciated by a person skilled in the art. In effect, the selection of appropriate input signal(s) ‘configures’ the hardware platform 325.

The hardware platform 325 is designed to model the wireless network using analogue and/or digital circuits, where voltage levels are preferably used to correspond to the various transmit (and/or receive) power levels found within the system. The outputs from the hardware platform 325 are then fed 340 back to the software platform 315 for further analysis. As would be appreciated by a skilled artisan, the interface between hardware and software is via analogue-to-digital and digital-to-analogue circuits.

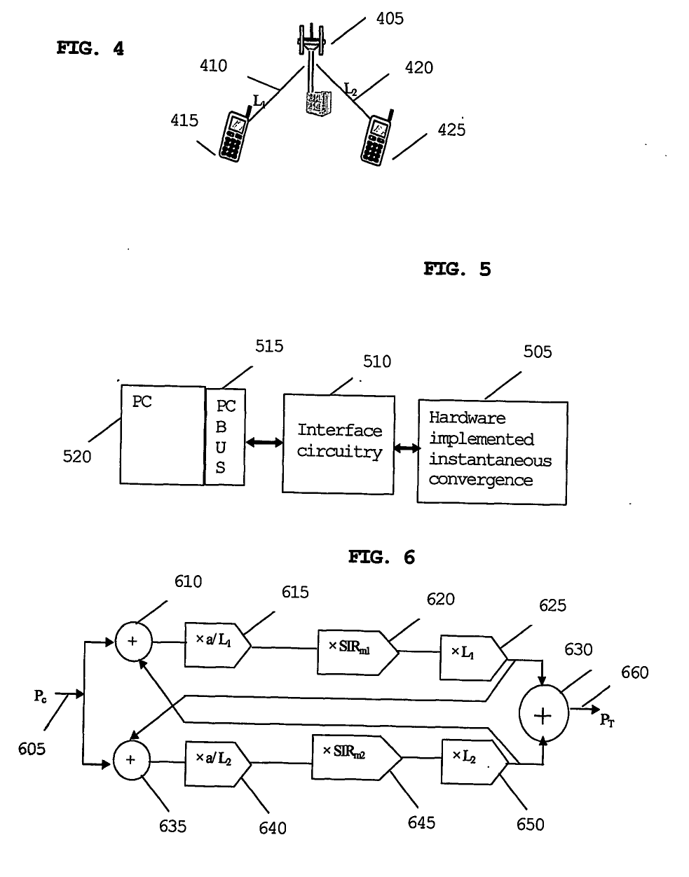

The purpose of a simulation in wideband CDMA (WCDMA) technology is to compute the power levels for all Node-B transmitters and all UEs in the network. However, and notably, all these entities are inter-dependent. For example, with reference to the very simple network diagram 400 of FIG. 4, the power transmitted from Node-B 405 on a first communication link 410 to UE-1 415 depends on the power transmitted on a second communication link 420 from Node-B 405 to UE-2 425, and vice versa. Clearly a wireless network would comprise many, many more communication elements than those shown, and therefore the interaction between each of the transmit powers is significantly affected.

The known mechanism for a simulation algorithm to solve this dichotomy is as follows. First, a simulation algorithm would estimate the power transmitted from Node-B 405 to UE-1 415. The simulation algorithm would then use recursive equations [7] and [8] below to calculate the power transmitted from Node-B 405 to UE-2 425. The simulation algorithm would then use recursive equations [5] and [6] below to calculate a new estimate for the power transmitted to UE-1 415. This process is then repeated by the simulation algorithm until the calculated powers reach a steady value (i.e. they have converged).

$${P}_{BS\_to \_m1} = {I}_{m 1} \times \frac{{( {E}_{b} / {N}_{0} )}_{BS\_to \_m1}}{C / {R}_{BS\_to \_m1}} \times {L}_{1} \qquad [ 5 ]$$

where:

$$\begin{matrix}{I}_{m 1} = ( {P}_{c} + {P}_{BS\_to \_m2} ) \times a \times \frac{1}{{L}_{1}} \\ and & [ 6 ] \\ {P}_{BS\_to \_m2} = {I}_{m 2} \times \frac{{( {E}_{b} / {N}_{0} )}_{BS\_to \_m2}}{C / {R}_{BS\_to \_m2}} \times {L}_{2} & [ 7 ]\end{matrix}$$

where:

$$\begin{matrix}{I}_{m 2} = ( {P}_{c} + {P}_{BS\_to \_m1} ) \times a \times \frac{1}{{L}_{2}} \\ and & [ 8 ] \\ {SIR}_{m} = {I}_{m 2} \times \frac{{( {E}_{b} / {N}_{0} )}_{BS\_to \_m}}{C / {R}_{BS\_to \_m}} & [ 9 ]\end{matrix}$$

and total traffic channel power is then:
P_{T}=P_{BS}_{_{—}}ₜₒ_{_{—}}ₘ₁+P_{BS}_{_{—}}ₜₒ_{_{—}}ₘ₂ [10]
where:

P_{c} is the control channel power of the Node-B 405, and P_{T} is the traffic channel power of the Node-B 405.

This is an iterative process where estimates of an unknown variable are fed back into known formulae in order to obtain progressively better estimates.

However, in accordance with the preferred embodiments of the present invention, it is proposed to use electronic feedback circuitry to eliminate the need to iterate altogether. Hence, it is possible for the simulation to reach a steady state solution in a much shorter time.

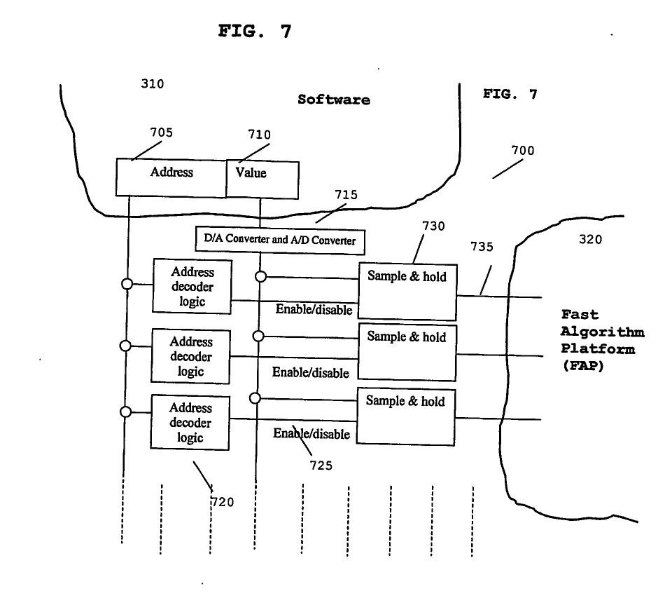

Referring now to FIG. 5, an overview of the interface circuitry required in order for the hardware platform to be configured under software control is illustrated, in accordance with the preferred embodiment of the present invention. The circuitry comprises a computer 520 that is operably coupled to interface circuitry 510 via a bus 515. The interface circuitry 510 is operably coupled to the proposed hardware implementation 505, which provides substantially instantaneous convergence of the data. The interface circuitry is further described with respect to FIG. 7.

Referring now to FIG. 6, a simplistic block diagram 600 of the preferred hardware circuitry used to implement the preferred embodiment of the present invention is illustrated. Here the entity of interest, i.e. the transmitter's power level has been modelled as a voltage. Two types of simple electronic components are used: adders and multipliers (or amplifiers). Adders produce at their output a voltage that is the sum of two or more input voltages. Multipliers produce at their output a voltage that is a scaled version of the input voltage. The components are wired in such a way as to implement the required feedback.

In the simplistic arrangement of FIG. 4, whereby a solution for two UEs is required, the hardware circuitry would comprise two inter-dependent paths. A first path for a first UE comprises an adder function 610, which receives and adds the input voltage Pc 605 together with a feedback voltage of the second UE. The output from the adder function 610 is input to a multiplier function 615, where it is scaled with respect to the parameter ‘a’ divided by the path loss L1. The output of the multiplier function 615 is also scaled with respect to a signal-to-interference ratio for the first UE, in multiplier function 620 and then again by the first path loss in multiplier function 625. The output of multiplier function 625 is then input to the second path at adder 635. Similarly, the same circuitry is used in the second path, with adder 635 followed by multiplier functions 640, 645 and 650. The output from the two paths is input to a final adder 630 and an output voltage P_{T} 660 is then returned to the software simulation algorithm.

Again with reference to FIG. 6, the input voltage Pc 605 is a known entity specified by the user of the system. Similarly the “gains” or the “scale factors” of the multipliers are known a priori and the circuit “solves” for P_{T}. It would be appreciated by a person skilled in the field that by ensuring minimal undesirable capacitive effects in the circuit, the time it would take for the output voltage to settle would be orders of magnitude faster than that possible by a software solution of the same problem.

As the circuitry can be implemented as a series of adder and multiplier functions, the circuitry can be readily implemented in an application specific integrated circuit (ASIC). As such, the ASIC can be adapted to include any number of UEs and Node-Bs, to simulate a practical network. Furthermore, the preferred embodiment of the present invention has been described with respect to downlink computations. However, it is envisaged that the same inventive concepts can also be extended to the uplink case. Advantageously, any other air interface parameters, such as radio resource management parameters, can also be readily accommodated within the analysis.

As mentioned, in the hardware platform the entity representing power in the radio network is voltage.

Thus, for example, the control channel power of the base station, P_{c}, is represented by a voltage that is input to the hardware platform by the software. Similarly, the software configures the hardware platform by setting one or more other parameters L1, L2, and

$$\frac{{( {E}_{b} / {N}_{0} )}_{BS\_to \_m}}{C / {R}_{BS\_to \_m}} .$$

The output of the hardware, P_{T}, is read back by the software. The extension to the full network can be described by the general equation presented above and the implementation presented in FIG. 6 may be scaled to achieve instantaneous convergence.

Referring now to FIG. 7, one embodiment of the interface circuitry 700 required in order for the hardware platform (say hardware platform 320 of FIG. 3) to be configured under software control (say software platform 310 of FIG. 3) is illustrated in accordance with the preferred embodiment of the present invention. With reference to FIG. 7, the hardware circuitry 320, termed here as a fast algorithm platform (FAP), illustrates the circuitry of FIG. 6, together with its extensions, in greater detail.

The user of the system specifies the inputs to the hardware circuitry 320, these being P_{c} and the “gains” of the multipliers of FIG. 6. The user will initially specify these in the Software component 310 of FIG. 7. This may be a direct input or preferably the data may be held in a database. Also, the values may be held directly or be derived from other data by means of pre-processing.

Upon user initiation, or by means of an automatic process, the software writes all the required values to a part of memory (which may be an external dedicated memory specifically used for this purpose). For each variable to be input to the FAP 320, the software 310 writes two pieces of information: an “Address” (or “ID”) 705, which identifies the variable and a “Value” 710 that is the value of the corresponding variable. The software 310 writes all the required input variables, in sequence, to the same memory location. The time lapse between each variable ‘write’ operation is selected to be long enough to ensure that the digital to analogue (D/A) conversion 715 and sample & hold operations 730 can be performed correctly.

Thus, upon writing an ‘address-value’ pair to the memory location, the D/A converter 715 converts the value to a voltage, which is then sampled and held by one, and only one, of the ‘sample & hold’ circuits 730. The ‘address’ of the variable determines which ‘sample & hold’ circuit 730 is active. This selection of a single circuit 730 is achieved as each ‘sample & hold’ circuit has an enable/disable input 725 and the address decoder logic blocks 720 are designed such that only the relevant ‘sample & hold’ circuit is enabled whilst the others are disabled. In this way all the required variables are made available to the FAP 320.

It is envisaged that a number of other mechanisms and circuit configurations could be used to transfer the data from software 310 to the FAP 320. However, the preferred mechanism described above offers the advantage that it uses the relatively simple ‘Sample & Hold’ and ‘decoder logic’ building blocks, these being the circuitry that needs to be replicated for each variable. This enables a single complex D/A circuit to be employed.

Effectively the same circuitry 700 is employed in order that the output of the hardware platform 320 is sampled and read back into the software platform's computer/processor 315. However, in this direction an analogue-to-digital converter operation is employed, as would be appreciated by a person skilled in the art.

Thus, the software sequences, through a set of “addresses” or “IDs” that it writes to the “address” memory location 705, each address corresponding to a variable being read from the FAP 320. The address decoder logic circuits 720 ensure that the relevant FAP output is routed through the correct ‘sample & hold’ circuit 730 to the D/A converter 715, which upon conversion makes the value available to the software 310. The sequence then repeats until all the required FAP outputs are read.

In summary, according to the present invention, the apparatus comprises a software-configurable hardware platform that models the air interface of a wireless communication network, achieves near-real-time simulation of the network and hence alleviates the need for and replaces time-consuming software implementations that are currently in use. The invention (by itself or as an essential component of a larger system) has applications in modelling, analysis, design and optimisation of radio networks.

In the alternative embodiment of applying the aforementioned inventive concepts in a preliminary network design simulation process, as compared to a real-time monitoring and adjustment of system parameters as described above, it is envisaged that the configuration of the hardware platform need not be static. In this regard, by arranging for the configuration of the network to vary in time, according to a pre-programmed sequence of events stored in the computer, the time-varying dynamical nature of the network can be precisely studied.

In this case, the operator defines a dynamic scenario by specifying the manner in which one or more parameter of the network changes with time, or alternatively the behaviour is predicted using location based information of the mobiles or is determined from network data logged as the network is operating. The sequence is stored in computer memory. When the operator initiates the analysis, for each time-step of the sequence, the specified configuration is translated to input voltages, applied to the hardware platform and the corresponding network state is read back and stored in the computer. The process is then repeated for each time-step. Hence a dynamic view of the network is built up corresponding to the dynamic scenario being studied.

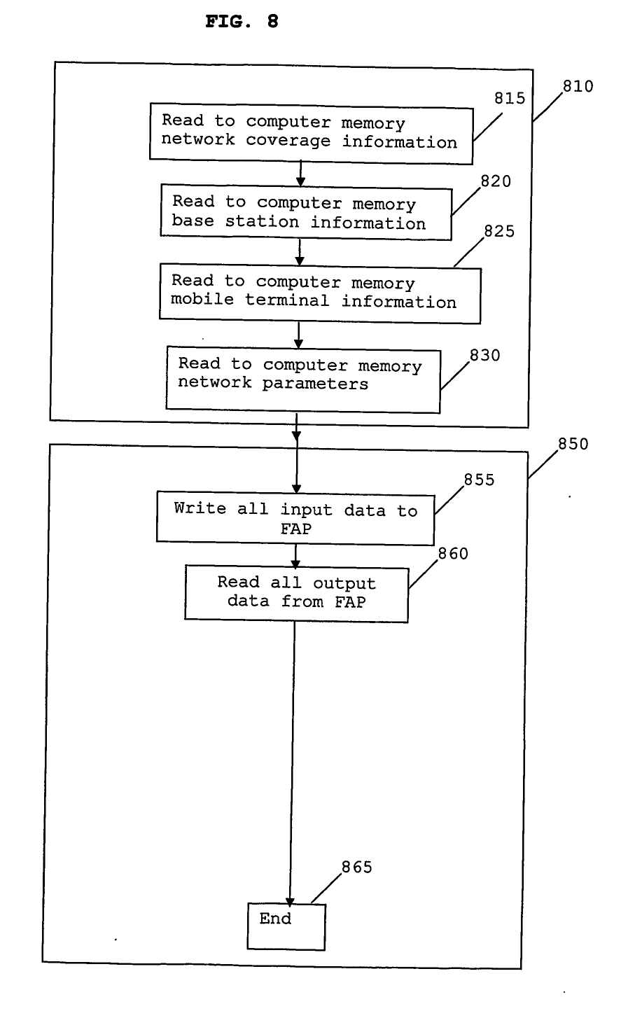

Referring now to FIG. 8, a flowchart 800 illustrates an overview of the preferred simulation process. The preferred simulation process uses the elements/steps of the known initialisation phase 810, with the network information being read into computer memory, such as coverage information in step 815, Node-B information in step 820, UE information in step 825 and network parameters in step 830.

However, in accordance with the preferred embodiment of the present invention, the network information is now read into the FAP circuitry, as described above, in step 855. The information from the FAP circuitry is then read out in step 860 and the process ends, in step 865. In this manner, there is no lengthy iteration process where new transmission powers are computed and interference scenarios run to see if the powers converge.

The preferred embodiment of the present invention has been described with regard to a cellular telephony communication system, such as the universal mobile telecommunications standard (UMTS). It is envisaged that the invention is equally applicable to other wireless CDMA, TDMA, FDMA or OFDMA communication systems. It is also within the contemplation of the invention that alternative radio communication architectures, such as private or public mobile radio communication systems could benefit from the inventive concepts described herein.

It is also within the contemplation of the present invention that the inventive concepts are not limited to use in simulating a wideband CDMA network. It is envisaged that the inventive concepts are equally applicable to any scenario where there exists a need to solve recursive equations similar to the ones detailed here. In particular, it is envisaged that the inventive concepts can be applied to any radio network, such as: static simulation of radio networks, dynamic simulation of radio networks, off-line optimisation of radio networks, on-line (or near-real-time) optimisation of radio networks, etc.

Clearly, a skilled artisan would appreciate the vast array of applications and opportunities that are made available to users through the inventive concepts described herein. In this regard, the examples provided above highlight only a snapshot of these.

It will be understood that the wireless communication system, improved OMC and improved method for resource (re-)planning, as described above, provides at least one or more of the following advantages that could not be reliably obtained using existing radio planning methods:
(i) It significantly reduces the time it takes a Network Operator to design and optimise a system.
(ii) The inventive concepts are equally applicable to automatic network optimisation techniques, to automate the whole process of radio network design for cellular operators.
(iii) The inventive concepts are equally applicable to on-going and substantially real-time adjustment of a wireless communication network, a feature that cannot be envisaged in today's large wireless networks.
(iv) It significantly reduces the time it takes a Network Designer to design and study the dynamic behaviour of the network.

Whilst the specific and preferred implementations of the embodiments of the present invention are described above, it is clear that a skilled artisan could readily apply variations and modifications of such inventive concepts.

Thus, a communication system, improved OMC and a method for simulator-driven cell configuration (re-)planning have been provided wherein the aforementioned disadvantages associated with prior art arrangements have been substantially-alleviated.

1. A method of simulating or designing a communication network supporting communication between a plurality of communication units, wherein the method comprises the step of:
employing a simulation tool to resolve a mathematical formula relating to an operation of the communication network; wherein the method is characterized by the step of:
resolving one or more iterative mathematical formula in hardware within a hardware platform of the simulation tool.

2. A method of simulating or designing a communication network according to claim 1, wherein the simulation tool further comprises a software platform, operably coupled to the hardware platform, and utilizes a series of mathematical formula at least one of which has no closed form solution, the method further characterized the step of:
resolving, by the hardware platform, the one or more mathematical formula that has no closed form solution.

3. A method of simulating or designing a communication network according to claim 2, wherein the method is further characterized by the step of:
providing, by the software platform, one or more input signals to the hardware platform, relating to the one or more mathematical formula to be resolved.

4. A method of simulating or designing a communication network according to claim 2, wherein the method is further characterized by the step of:
configuring the hardware platform, by the software platform, by setting one or more parameters of the mathematical formula to be resolved, for example one or more path-loss parameters and/or a parameter in the equation:
$$\frac{{( {E}_{b} / {N}_{0} )}_{BS\_to \_m}}{C / {R}_{BS\_to \_m}} .$$

5. A method of simulating or designing a communication network according to claim 3, wherein the one or more input signals are in the form of an electrically variable signal, for example a voltage level, where a level of the electrically variable signal corresponds to a transmit (or receive) power level of a communication unit operating in the communication network.

6. A method of simulating or designing a communication network according to claim 5, wherein the mathematical formula relate to an air-interface of a wireless communication network having communication units that are capable of transmitting at differing radio frequency transmit powers, wherein the step of resolving comprises the step of converging a number of the transmit powers.

7. A method of simulating or designing a communication network according to claim 1, wherein the method is further characterized by the step of:
adapting an operational communication network, for example in substantially in a real-time manner, in response to one or more output provided by the hardware platform.

8. A method of simulating or designing a communication network according to claim 3, wherein the method is further characterized by the step of:
simulating a variation of a location of communication units as a function of time by adapting one or more input signal levels.

9. A method of simulating or designing a communication network according to claim 3, wherein the method is further characterized in that the one or more input signal levels relate to any one or more of the following:
(i) A geographical area to be covered by the communication network;
(ii) A number of subscriber units for which a simulation is to be performed;
(iii) An operational status of one or more subscriber units, for example whether a subscriber unit is mobile or static;
(iv) A power emission level from a subscriber unit and/or base station; or
(v) An operational setting of one or more base station.

10. A method of simulating or designing a communication network according to claim 1, wherein the method is applied to a wireless CDMA, TDMA, FDMA or OFDMA communication network.

11. A method of simulating or designing a communication network according to claim 1, wherein the method is applied to one or more of the following:
(i) A static simulation of a wireless communication network;
(ii) A dynamic simulation of a wireless communication network;
(iii) An off-line optimization of a wireless communication network; or
(iv) An on-line (or substantially near-real-time) optimization of a wireless communication network.

12. A communication network adapted to support the method steps of claim 1.

13. A communication unit, such as an Operations and Management Centre (OMC) of a 3G communication network, adapted to support the method steps of claim 1.

14. A storage medium storing processor-implementable instructions for controlling a processor to carry out the method steps of claim 1.

15. A simulation tool, adapted to support the method steps of claim 1.

16. A simulation tool, for simulating or designing a communication network supporting communication between a plurality of communication units, comprising a software platform, wherein the simulation tool is characterized by:
a hardware platform operably coupled to the software platform such that the hardware platform is configured to resolve one or more iterative mathematical formula relating to an operation of the communication network.

17. A simulation tool according to claim 16, wherein the hardware platform is configured to resolve one or more mathematical formula that has no closed form solution.

18. A simulation tool according to claim 16, wherein the simulation tool comprises an interface between the software platform and the hardware platform to enable the software platform to provide one or more input signals to the hardware platform, relating to the one or more mathematical formula to be resolved.

19. A simulation tool according to claim 16, wherein the software platform is capable of configuring the hardware platform by setting one or more parameters of the mathematical formula to be resolved, for example, one or more path-loss parameters and/or a parameter in equation:
$$\frac{{( {E}_{b} / {N}_{0} )}_{BS\_to \_m}}{C / {R}_{BS\_to \_m}}$$

20. A simulation tool according to claim 18, wherein the one or more input signals are in the form of an electrically variable signal, for example a voltage level, where a level of the electrically variable signal corresponds to a transmit (or receive) power level of a communication unit operating in the communication network.

21. A simulation tool according to claim 18, wherein the software platform adapts one or more input signals in order to simulate a variation of a location of at least one communication unit as a function of time.

22. A simulation tool according to claim 18, wherein the one or more input signal levels relate to any one or more of the following:
(i) A geographical area to be covered by the communication network;
(ii) A number of subscriber units for which the simulation is to be performed;
(iii) An operational status of one or more of the subscriber units, for example whether a subscriber unit is mobile or static;
(iv) A power emission from a subscriber unit and/or base station; or
(v) An operational setting of one or more base station(s).

23. A simulation tool according to claim 16, wherein the hardware platform comprises a plurality of substantially only two electronic components: adder functions and multiplier functions.

24. A simulation tool according to claim 18, wherein the interface comprises a plurality of sample and hold functions and ‘decoder logic’ building blocks.

25. A simulation tool according to claim 16, wherein the hardware platform is configured to resolve an equation of a form:
$${I}_{m} = {\sum }_{n = 1 , n \neq s}^{Nbs} {P}_{n} \times \frac{1}{{L}_{n}} + ( {P}_{s} - P m ) \times \frac{1}{{L}_{s}} \times a$$

26. A simulation tool according to claim 16, wherein the hardware platform is configured to resolve an equation of a form:
$${I}_{m} = {\sum }_{n = 1 , n \neq s}^{{N}_{m}} {P}_{m} \times \frac{1}{{L}_{n}} + ( {P}_{s} - {P}_{m\_to \_BS} ) \times \frac{1}{{L}_{s}}$$

27. A simulation tool according to claim 16, wherein the simulation tool is located in an Operations and Management Centre of a wireless communication network.

28. A simulation tool according to claim 16, wherein the simulation tool is arranged to adapt an operational communication network in substantially in a real-time manner in response to an output provided by the hardware platform.

29. A cellular communication system adapted to employ the simulation tool of claim 16.

30-32. (canceled)
